(19) United States
(12) Patent Application Publication
(10) Pub. No.: US 2014/0209061 A1
(43) Pub. Date: Jul. 31, 2014

(54) ENGINE BRAKE IMPROVEMENT

(71) Applicant: NAVISTAR DEFENSE ENGINEERING, LLC, Lisle, IL (US)

(72) Inventors: Jose Antonio Marques Neto, Darien, IL (US); William McCoy, Fort Wayne, IN (US); Rodger Michael Miller, Plainfield, IL (US); Brian William Petersen, Chicago, IL (US); Victor S. Bertl, Warrenville, IL (US)

(73) Assignee: NAVISTAR DEFENSE ENGINEERING, LLC, Lisle, IL (US)

(21) Appl. No.: 13/752,467

(22) Filed: Jan. 29, 2013

(51) Int. Cl. F02D 13/04

(52) U.S. Cl. CPC F02D 13/04
USPC 123/320

(57) ABSTRACT

A system and method for improving the engine braking capacity for a vehicle is disclosed. The system and method include providing a compression release braking system, providing an energy drawing component for increasing power draw on the vehicle engine, and, increasing the engine braking capability by synchronizing operation of the energy drawing component with operation of the compression release braking system. The energy drawing component includes a hydraulic fan, which is part of the cooling system of the vehicle. Increasing the speed of the fan draws energy from the engine, which in turn, increases the braking capability of the engine.

### TECHNICAL FIELD

The present system and method relate to increasing the engine braking capability of a vehicle. More specifically, the system and method relate to coordinating the use of a hydraulic fan from the cooling system of the vehicle with the compression braking system to increase overall engine braking capabilities.

### BACKGROUND

Engine braking occurs when the retarding forces within an engine are used to slow a vehicle down, as opposed to using an external braking mechanism such as friction brakes or magnetic brakes. Large vehicles, including large diesel trucks typically use a compression release brake, also known as “Jacob brake” or “Jake brake.” This type of brake is most commonly confused with real engine braking; it is used mainly in large diesel trucks and works by opening the exhaust valves at the top of the compression stroke, resulting in adiabatic expansion of the compressed air, so the large amount of energy stored in the compressed air is not returned to the crankshaft, but is released into the atmosphere.

Normally during the compression stroke, energy is used as the upward-traveling piston compresses air in the cylinder. The compressed air then acts as a compressed spring and pushes the piston back down. However, with a Jake brake in operation, the compressed air is suddenly released just before the piston begins its downward travel. This sudden release of compressed air creates audible sound waves similar to the expanding gases escaping from the muzzle of a firearm. Having lost the energy stored within the compressed air, the engine is then made to pull the piston down, which draws new air into the cylinder, and then travel upward again, compressing the new volume of air, which will again be released to the atmosphere after having been compressed. Though this action, the engine loses energy. The efficiency of the engine brake could be measured due to engine boost pressure increase and how fast the engine decreases the speed.

The use of compression release engine brakes may cause a vehicle to make a loud chattering or “machine gun” noise, especially vehicles having high flow mufflers, or no mufflers at all, causing many communities in the United States to prohibit compression braking within municipal limits. Therefore, given these restrictions, there is a need to increase the engine braking capacity. The present system and method incorporates use of a hydraulic fan, which is already part of the cooling system of the vehicle, to further increase the energy or power load on the engine, resulting in reduced speed and maximizing braking performance.

### SUMMARY

There is disclosed herein an improved system and method for increasing the engine braking capacity of a vehicle engine, which avoids the disadvantages of prior systems while affording additional structural and costs advantages.

Generally speaking, the present system and method relates to increasing the engine braking capacity of an engine, through increasing the speed of a hydraulic fan in synchrony with application of the engine braking system.

A method for increasing engine brake capability of a vehicle engine, is disclosed. In an embodiment, the method includes the steps of providing a compression release braking system, providing an energy drawing component for increasing power draw on the vehicle engine, and, increasing the engine braking capability by synchronizing operation of the energy drawing component with operation of the compression release braking system.

A system for increasing engine braking capacity on a vehicle, is disclosed. In an embodiment, the system includes a compression release brake, a power absorbing component of a cooling system and, a controller for integrating operation of the power absorbing component with the compression release brake to increase the braking capacity of the engine.

These and other features and advantages of the engine braking system and method can be more readily understood from the following detailed discussion with reference to the appended drawing figures

### BRIEF DESCRIPTION OF THE DRAWINGS

FIG. 1 is a schematic view of the present engine braking system incorporating the cooling system fan;

FIG. 2 is a perspective view of the cooling system fan used in the present engine braking system and method, and,

FIG. 3 is a chart showing improved engine braking performance through use of the present system.

### DETAILED DESCRIPTION

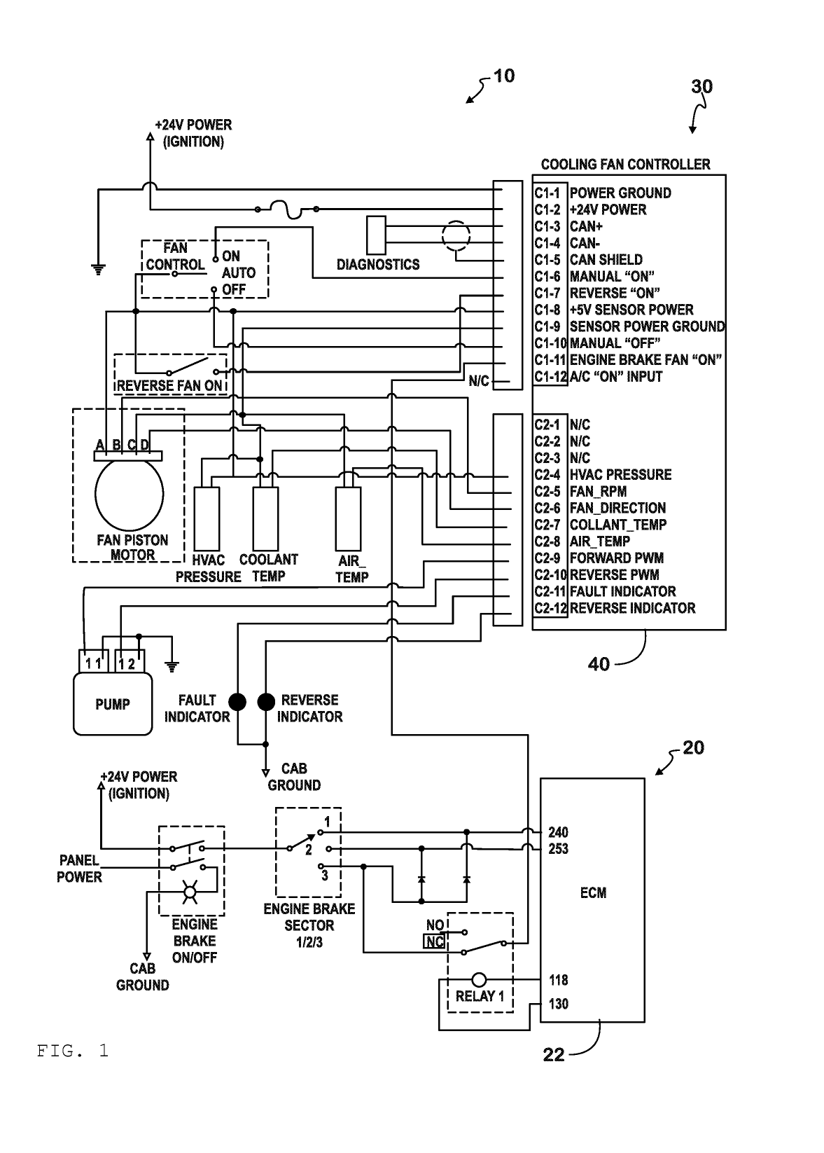

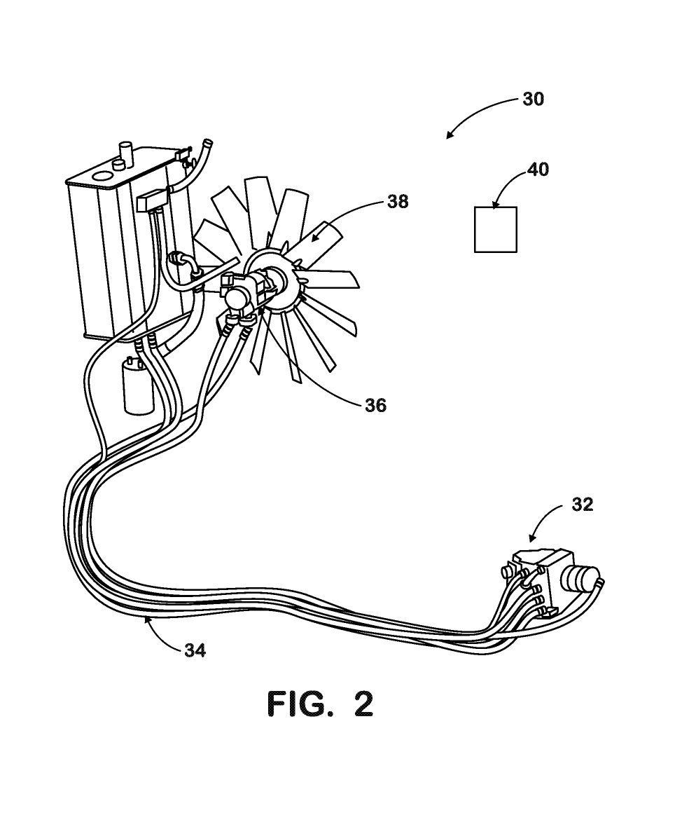

Referring to FIGS. 1-2, there is illustrated an embodiment of the enhanced engine braking system, generally designated by the numeral 10, as well as the components thereof. The present engine braking system is useful in a vehicle (not shown), including a large diesel engine truck to increase the braking capacity of the vehicle. Previously, large vehicles and trucks relied only on a Jake brake system for braking. The present system and method incorporates an additional energy drawing component to further enhance the braking capability of the standard braking system.

FIG. 1 illustrates a schematic embodiment of the engine braking system 10 of the present disclosure. The system 10 includes the standard engine braking system 20 and the cooling system 30. The engine braking system 20 and its components are controlled by an electronic control module (ECM) 22. The components of the engine braking system 20 and of the cooling system 30 are well-known and will not be described in further detail, with the exception of how they may relate to the present improved braking system.

FIG. 2 illustrates the cooling system 30. The cooling system 30 is a hydraulic cooling system for use in internal combustion engines using a radiator to lower the temperature of the engine coolant by transferring heat of the coolant to the ambient air. The cooling system 30 includes a hydraulic pump 32 adapted to be driven by the associated engine. Through conduits 34, the pumped pressurized fluid is transferred to a hydraulic fan motor 36, which operates the hydraulic fan 38, such that the fan is rotated as the motor is energized by the pumped fluid. In the present system 10, operation of the hydraulic fan 38 is controlled by an electronic fan controller 40.

As mentioned, engine braking occurs when the retarding forces within an engine are used to slow down a vehicle, as opposed to using an external braking mechanism, such as friction brakes or magnetic brakes. Therefore, in an effort to increase the engine braking capacity, the present system incorporates the use of the hydraulic fan 38 from the cooling system 30. The hydraulic fan 38 is a power consumer of energy, and therefore, the fan is used as an energy drawing component on the engine. The fan power is proportional to the fan speed (P₁/P₂=(n₁/n₂)³). Therefore, running the fan at a maximum speed, results in greater power drag and subsequent slow down of the engine, which reduces the engine speed and maximizes the engine braking performance.

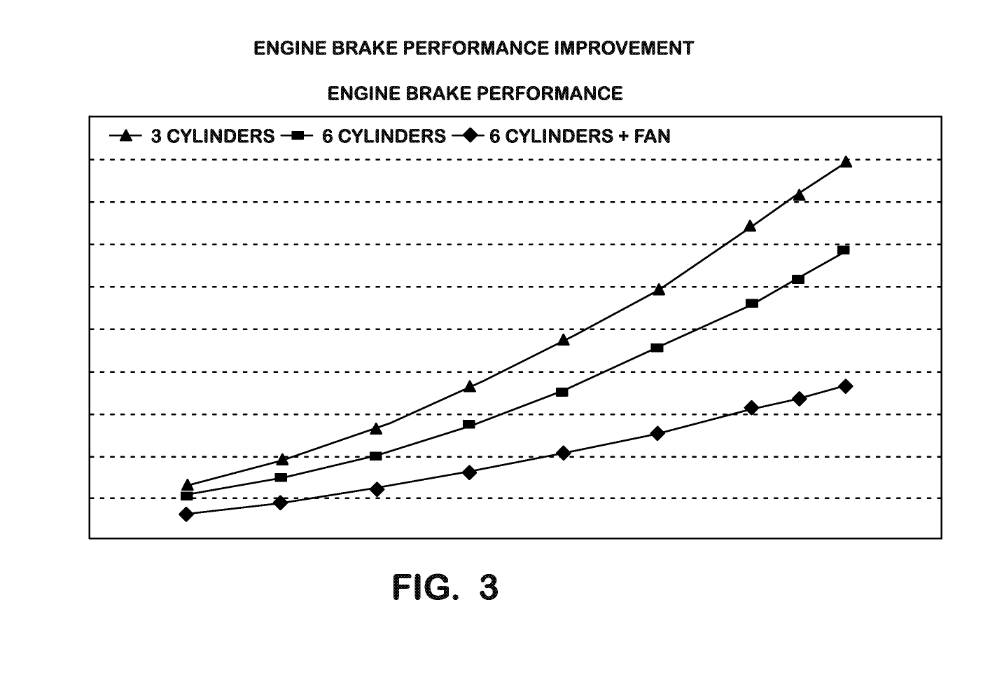

Operation of the hydraulic fan 38 is synchronized with the operation of the compression brake system 20 through use of the fan electronic controller 40. For example, when the driver steps off the accelerator pedal (not shown), a signal is sent to the fan electronic controller 40, which then activates the hydraulic fan 38. The hydraulic fan 38 starts running up to a maximum speed, which then pulls energy from the engine, slowing the engine down in coordination with the compression braking system 20. Use of the fan 38 synchronized with the compression braking system 20 improves the overall braking capacity of the engine. FIG. 3 illustrates the improved engine brake performance of a 6 cylinder engine when the fan 38 is incorporated into the engine braking system (triangles), over the 6 cylinder engine without use of the fan (squares).

The speed of the fan 38 will vary up to the maximum speed depending on the heat exchange requirements of the engine. The speed of the fan 38 is proportionally driven up to the maximum speed depending on required heat rejection or in other words, in response to the temperature of the coolant radiator inlet (not shown) and CAC intake air outlet (not shown). Because operation of the hydraulic fan 38 draws significant energy from the engine, the cooling system 30 is designed to operate the fan at the maximum speed only under specific conditions, to avoid performance and fuel penalties.

What is claimed is:

1. A method for increasing engine braking capability of a vehicle engine, the method comprising the steps of:
providing a compression release braking system;
providing an energy drawing component for increasing power draw on the vehicle engine; and,
increasing the engine braking capability by synchronizing operation of the energy drawing component with operation of the compression release braking system.

2. The method for increasing engine braking capability of claim 1, wherein the energy drawing component includes a hydraulic fan.

3. The method for increasing engine braking capability of claim 2, wherein the method further includes controlling the hydraulic fan for regulating the power draw on the engine.

4. The method for increasing engine braking capability of claim 3, wherein the step of controlling the hydraulic fan includes an electronic controller.

5. The method for increasing engine braking capability of claim 4, wherein electronic controller sets a variable speed for the hydraulic fan.

6. The method for increasing engine braking capability of claim 5, wherein the hydraulic fan is set at a maximum speed for increasing a power draw on the engine.

7. The method for increasing engine braking capability of claim 5, wherein the increasing the power draw on the engine increases braking capability of the compression release braking system.

8. A system for increasing engine braking performance on a vehicle, the system comprising:
a compression release brake;
a power absorbing component of a cooling system; and,
a controller for integrating operation of the power absorbing component with the compression release brake to increase the braking capacity of the engine.

9. The system of claim 8, wherein the controller is an electronic controller to integrate operation of the power absorbing component with the compression release brake.

10. The system of claim 9, wherein the power absorbing component is a hydraulic fan incorporated into a cooling system for the vehicle.

11. The system of claim 10, wherein the electronic controller controls a speed level of the fan.

12. The system of claim 11, wherein increasing the speed of the fan reduces power to the engine and increases the braking capacity of the engine.
